(19) United States
(12) Patent Application Publication
(10) Pub. No.: US 2025/0386969 A1
(43) Pub. Date: Dec. 25, 2025

(54) HEAT INSULATION STRUCTURE OF ROASTING MACHINE

(71) Applicant: CHING-CHUAN YU, Taichung City (TW)

(72) Inventor: CHING-CHUAN YU, Taichung City (TW)

(21) Appl. No.: 19/243,459

(22) Filed: Jun. 19, 2025

(30) Foreign Application Priority Data
Jun. 23, 2024 (TW) 113123291

(51) Int. Cl. A47J 37/04

(52) U.S. Cl. CPC A47J 37/049; A47J 37/041; A47J 37/047

(57) ABSTRACT

A heat insulation structure of a roasting machine, the roasting machine contains a body which has a roller, a transmission mechanism, and a heating unit. The roller including a roast room to accommodate crops, the heating unit is mounted on the body, and the transmission mechanism actuates the roller to rotate. The body includes a closed heat exchange space to correspond to the roller, the heat exchange space includes an inlet configured to flow airs from an external environment, and the heat exchange surrounds the body and communicates with the roasting room. The heat exchange room extends into the roasting room along the body and does not pass through the heating unit to increase a flow of the airs and a heat exchanging time of the body, thus saving an energy loss of the heating unit and maintaining the temperature of the roast room stably.

### TECHNICAL FIELD

The present invention relates to a crop roasting machine, and more particularly to a heat insulation structure of a roasting machine.

### BACKGROUND

When fruits, vegetables, crops or coffee beans need to be dried to reduce their moisture content, they are usually placed inside a roaster for roasting and heating. During the roasting and heating process or just after the roasting and heating is completed, the outermost layer of the roasting chamber wall will be in a high temperature state, which is not only easy to cause burns by accidental touch, but also the heat energy generated during the roasting process is lost and wasted.

Referring to FIG. 8, a conventional roasting machine has a semi-hot air structure, which includes a furnace body C1, a heat outlet C2 is provided at one end of the furnace body C1, and a rotating drum C3 is provided inside. The rotating drum C3 rotates by an axis C4, and coffee beans C5 are contained inside the rotating drum C3. A heat source C9 is directly provided at the bottom of the rotating drum C3 for heating. FIG. 9 shown a fully hot air structure of a conventional roasting machine, which includes a furnace body C1, a heat outlet C2 at one end of the furnace body C1, a rotating drum C3 inside, the rotating drum C3 rotates by the axis C4, and coffee beans C5 are contained inside the rotating drum C3. An inner partition C61 and an outer partition C62 are provided at the bottom of the rotating drum C3, so that a channel C7 is formed between the furnace body C1 and the inner partition C61 and the outer partition C62. A heat inlet C8 is provided at the bottom of the channel C7, and a heat source C9 is provided on one side of the heat inlet C8. When the heat source generates a flame, the airflow from the outside is used to generate hot air through the flame to roast the coffee beans C5 in the rotating drum C3.

Above mentioned conventional roasting machines, the heat source for generating flames is located at the air inlet. When the outside air flows through the heat source into the drum, not only will the flame flicker and affect the heating temperature, causing a great change in the overall heating temperature, which results in a great loss of heating energy, but also the temperature of the furnace body will be transferred to the outer layer due to the high temperature, which is easy to cause burns if touched.

The present invention has arisen to mitigate and/or obviate the afore-described disadvantages.

### SUMMARY

The primary aspect of the present invention is to provide a heat insulation structure of a roasting machine which is capable of separating a heat when roasting crops, and a heat of the airs flowing into the roast room is exchanged with a heat of the roasting machine for preheating, thus avoiding a high temperature of the body and saving a heat energy.

To obtain above-mentioned aspect, a heat insulation structure of a roasting machine, the roasting machine contains a body in which a roller is fixed, a transmission mechanism, and a heating unit. The roller includes a roast room defined therein to accommodate crops, and the heating unit is mounted on the body. The transmission mechanism actuating the roller to rotate, when the crops are heated by the roasting machine.

The body includes a closed heat exchange space defined on a top thereof to correspond to the roller, the heat exchange space includes an inlet formed on an end thereof and configured to flow airs from an external environment, and the other end of the heat exchange surrounds the body and communicates with the roasting room of the roller. The heat exchange room extends into the roasting room of the roller along the body and does not pass through the heating unit to increase a flow of the airs and a heat exchanging time of the body, thus saving an energy loss of the heating unit and maintaining the temperature of the roast room stably.

Preferably, the heat exchange room extends into the roasting room of the roller along the body in an S shape to increase a flow of the airs and a heat exchanging time of the body.

Preferably, the closed heat exchange space of the body corresponds to the roller and includes a covering element configured to shield the roller and cover by a protective lid, and the protective lid has two first partitions connected on two ends thereof, the covering element has two second partitions connected on two ends thereof, and a third partition is disposed on a bottom of the protective lid; the two second partitions extends to an inner wall of the protective lid, wherein an end of one second partition is connected with a bottom of the covering element, and an end of the other second partition is connected with the third partition, two sides of the second partition correspond to the bottom of the covering element and has an opening defined among the two sides of the covering element and the inner wall of the protective lid, wherein a fourth partition is connected on a top of the opening, and a conduit is defined between the roller and the covering element and communicates with a conduit of a roast room, a first flow passageway and a second flow passageway are defined between the protective lid and the covering element, such that the conduit, the first flow passageway and the second flow passageway define the heat exchange space, wherein the first flow passageway has an air feeding mouth defined on a top of an end thereof; the second partition is configured to separate the first flow passageway from the second flow passageway and has at least one first communication portion defined on a predetermined position thereof so that the first flow passageway is communicated with the second flow passageway; the covering element includes a second communication portion corresponding to the second flow passageway so that the second flow passageway is communicated with the conduit, and the airs flow into the roast room from the air feeding mouth via the first passageway, the second passageway and the conduit.

Preferably, the covering element has a heat insulation layer covering on an outer wall thereof to isolate a heat dissipation from the roller, thus maintaining a heat and avoiding a high temperature of the rotating machine.

Preferably, the roller includes an internal cylinder and an external cylinder, the roast room is defined in the internal cylinder to accommodate crops, the external cylinder is hollowly cylindrical and is located outside the internal cylinder, wherein multiple fins are defined between the internal cylinder and the external cylinder so that the internal cylinder suspends inside the external cylinder, and multiple channels are defined between the internal cylinder and the external cylinder and communicates with the roast room; the conduit communicates with the multiple channels, wherein the airs flow into the roast room via the first flow passageway, the second flow passageway, the conduit and the multiple channels.

Preferably, the first communication portion is a cutout or a through hole.

### BRIEF DESCRIPTION OF THE DRAWINGS

FIG. 1 is a perspective view showing the assembly of a heat insulation structure of a roasting machine according to a preferred embodiment of the present invention.

FIG. 2 is a cross sectional view showing the assembly of the heat insulation structure of the roasting machine according to the preferred embodiment of the present invention.

FIG. 3 is another cross sectional view showing the assembly of the heat insulation structure of the roasting machine according to the preferred embodiment of the present invention.

FIG. 4 is another cross sectional view showing the assembly of a part of the heat insulation structure of the roasting machine according to the preferred embodiment of the present invention.

FIG. 5 is another cross sectional view showing the assembly of the heat insulation structure of the roasting machine according to the preferred embodiment of the present invention.

FIG. 6 is a cross sectional view showing the operation of the heat insulation structure of the roasting machine according to the preferred embodiment of the present invention.

FIG. 7 is another cross sectional view showing the operation of the heat insulation structure of the roasting machine according to the preferred embodiment of the present invention.

FIG. 8 is a cross sectional view of a conventional roasting machine.

FIG. 9 is a cross sectional view of another conventional roasting machine.

### DETAILED DESCRIPTION

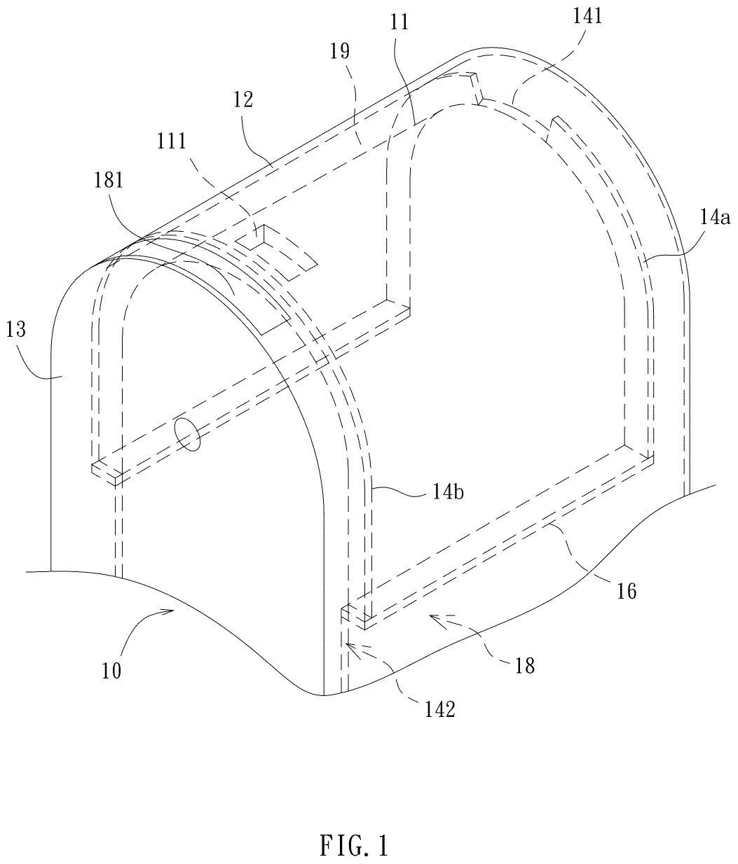

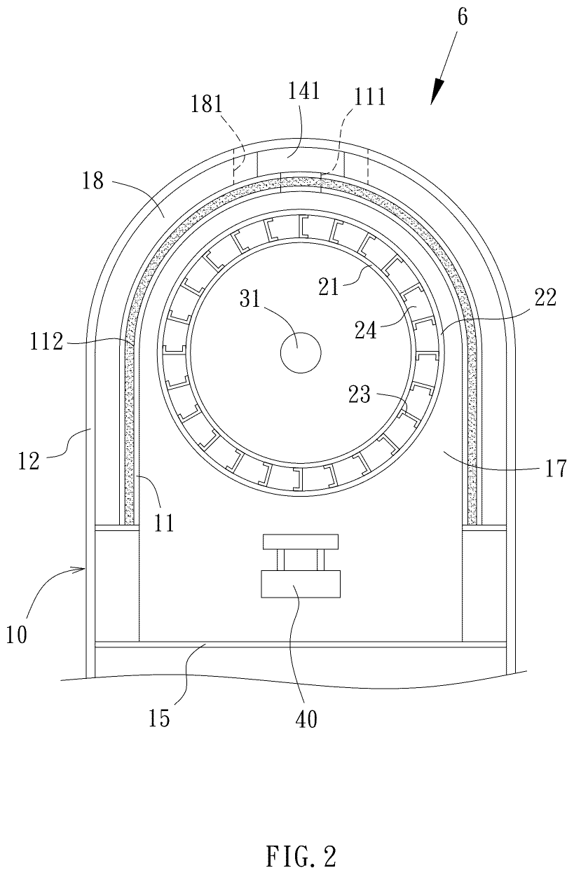

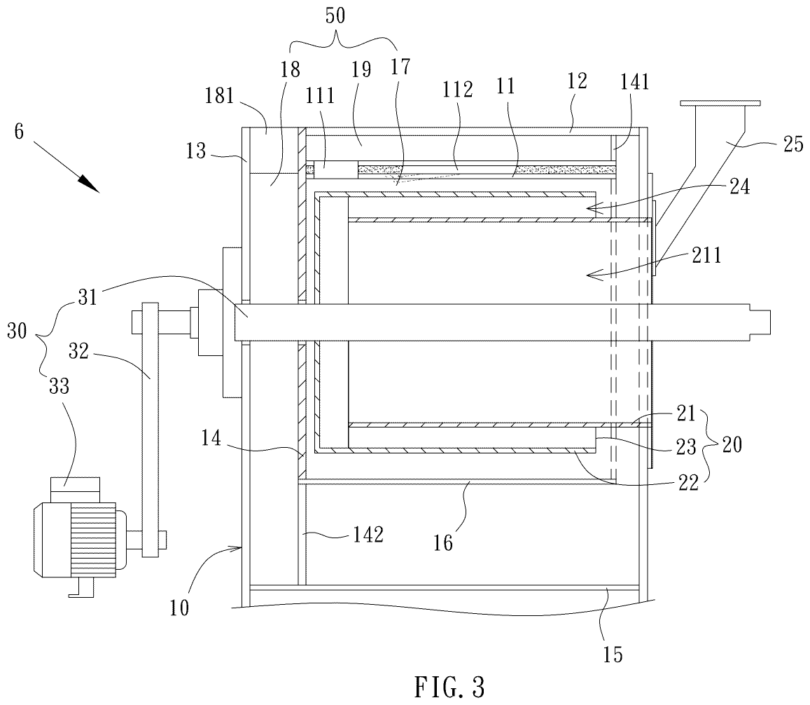

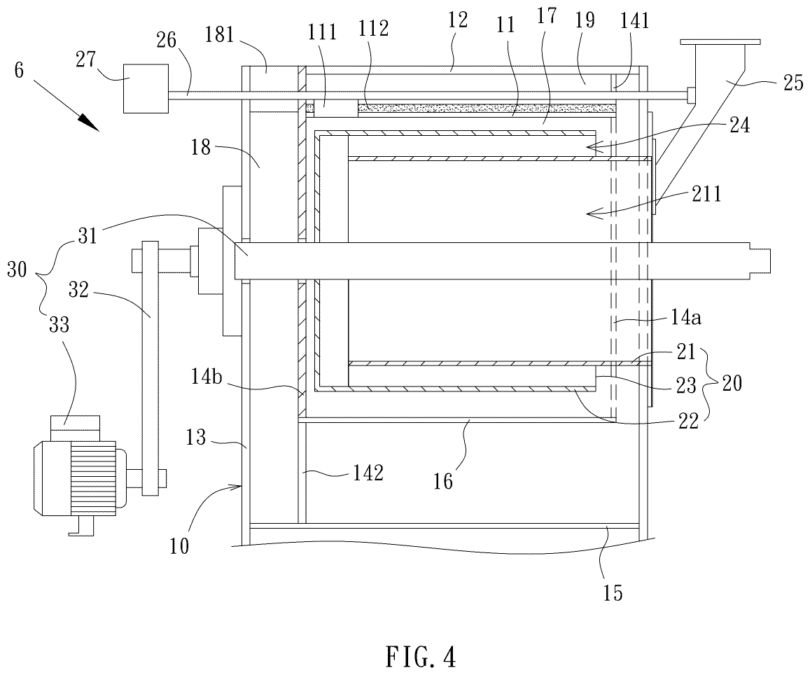

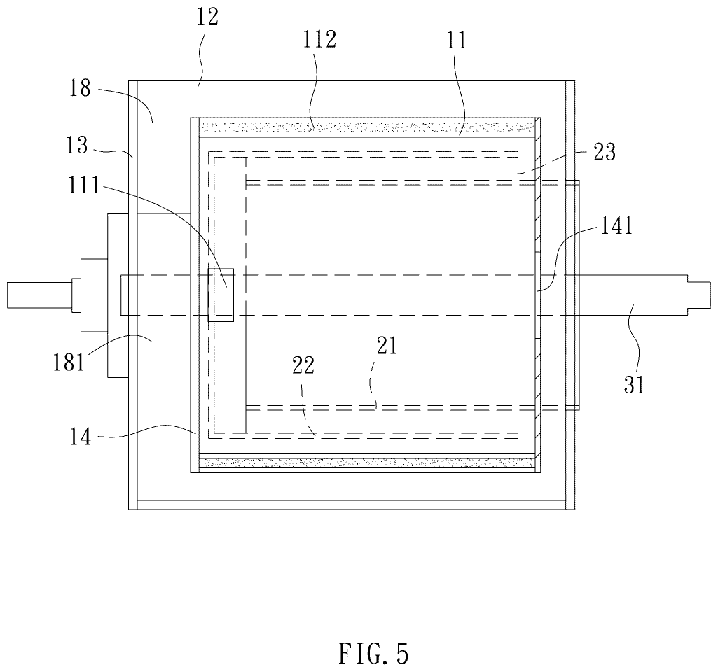

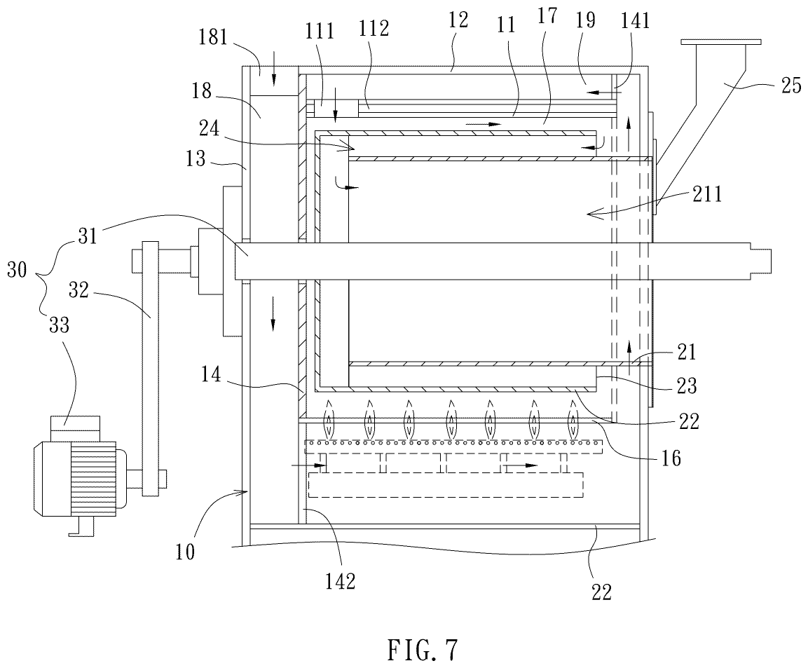

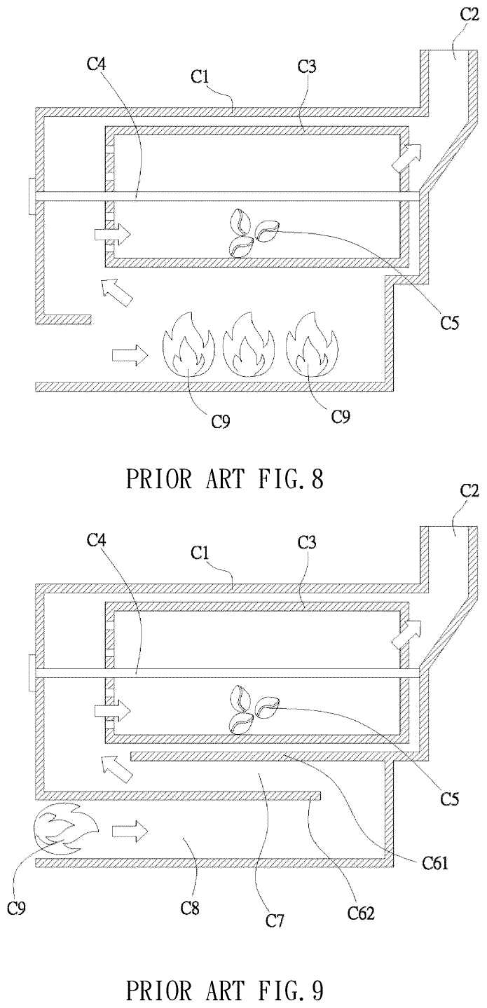

With reference to FIGS. 1-7, a heat insulation structure of a roasting machine 6 according to a preferred embodiment of the present invention, the roasting machine 6 includes a body 10 in which a roller 20 is fixed, a transmission mechanism 30, and a heating unit 40.

The body 10 is supported by a rack (not shown), and the roller 20 is fixed on a top of the body 10, the body 10 includes the heating unit 40 mounted on a bottom thereof, a closed heat exchange space 50 defined on the top of the body 10 to correspond to the roller 20, wherein the heat exchange space 50 includes an inlet formed on an end thereof and configured to flow airs from an external environment, and the other end of the heat exchange 50 surrounds the body 10 and communicating with a roasting room of the roller 20. When the heat exchange room 50 extends into the roasting room of the roller 20 along the body 10 in an S shape and does not pass through the heating unit 40 to increase a flow of the airs and a heat exchanging time of the body 10.

The closed heat exchange space 50 of the body 10 corresponds to the roller 20 and includes a covering element 11 configured to shield the roller 20 and cover by a protective lid 12, and the protective lid 12 has two first partitions 13 connected on two ends thereof, the covering element 11 has two second partitions 14a, 14b connected on two ends thereof, and a third partition 16 is disposed on a bottom of the protective lid 12. The two second partitions 14a, 14b extends to an inner wall of the protective lid 12, wherein an end of one second partition 14a is connected with a bottom of the covering element 11, and end of the other second partition 14a is connected with the third partition 15, and two sides of the second partition 14b correspond to the bottom of the covering element 11 and has an opening 142 defined among the two sides of the covering element 11 and the inner wall of the protective lid 12, wherein a fourth partition 16 is connected on a top of the opening 142, and a conduit 17 is defined between the roller 20 and the covering element 11 and communicates with a conduit 17 of a roast room 211, a first flow passageway 18 and a second flow passageway 19 are defined between the protective lid 12 and the covering element 11, such that the conduit 17, the first flow passageway 18 and the second flow passageway 19 define the heat exchange space 50, wherein the first flow passageway has an air feeding mouth 181 defined on a top of an end thereof. The second partition 14b is configured to separate the first flow passageway 19 from the second flow passageway 19 and has at least one first communication portion 141 defined on a predetermined position thereof so that the first flow passageway 18 is communicated with the second flow passageway 19, wherein the first communication portion 141 is a cutout or a through hole. The covering element 11 includes a second communication portion 111 corresponding to the second flow passageway 19 and is a through hole so that the second flow passageway 19 is communicated with the conduit 17, and airs flow into the roast room 211 from the air feeding mouth 181 via the first passageway 18, the second passageway 19 and the conduit 17. The covering element 11 has a heat insulation layer 112 covering on an outer wall thereof to isolate a heat dissipation from the roller 20, thus maintaining a heat and avoiding a high temperature of the rotating machine. The protective lid 12 and the two first partitions 13 are one-piece formed or is a connected element, and the covering element 11 and the two second partitions 14a, 14b are one-piece formed or is a connected element.

The roller 20 is hollow cylindrical and is a sole-layer element or a double-layer element (such as an internal cylinder 21 and an external cylinder 22), when the roller 20 is the double-layer element, the roast room 211 is defined in the internal cylinder 21 to accommodate crops. The external cylinder 22 is hollowly cylindrical and is located outside the internal cylinder 21, wherein multiple fins 23 are defined between the internal cylinder 21 and the external cylinder 22 so that the internal cylinder 21 suspends inside the external cylinder 22, and multiple channels 24 are defined between the internal cylinder 21 and the external cylinder 22 and communicates with the roast room 211. The conduit 17 communicates with the multiple channels 24, wherein the airs flow into the roast room 211 via the first flow passageway 18, the second flow passageway 19, the conduit 17 and the multiple channels 24. The roller 20 includes a feeding cylinder 25 connected on an outer wall thereof and covered by a cap, wherein the feeding cylinder 25 communicates with the roast room 211, such that the crops are fed into the roast room 211 from the feeding cylinder 25 so that high-temperature airs are discharged out of the feeding cylinder 25. In another embodiment, an end of a discharge tube 26 is connected with the feeding cylinder 25, and the other end of the discharge tube 26 is inserted through the first partition 13 to connected with an exhaust unit 27 via the first communication portion 141, the conduit 17, and the second partition 14a, hence the airs are discharged out of the roast room 211 by using the exhaust unit 27.

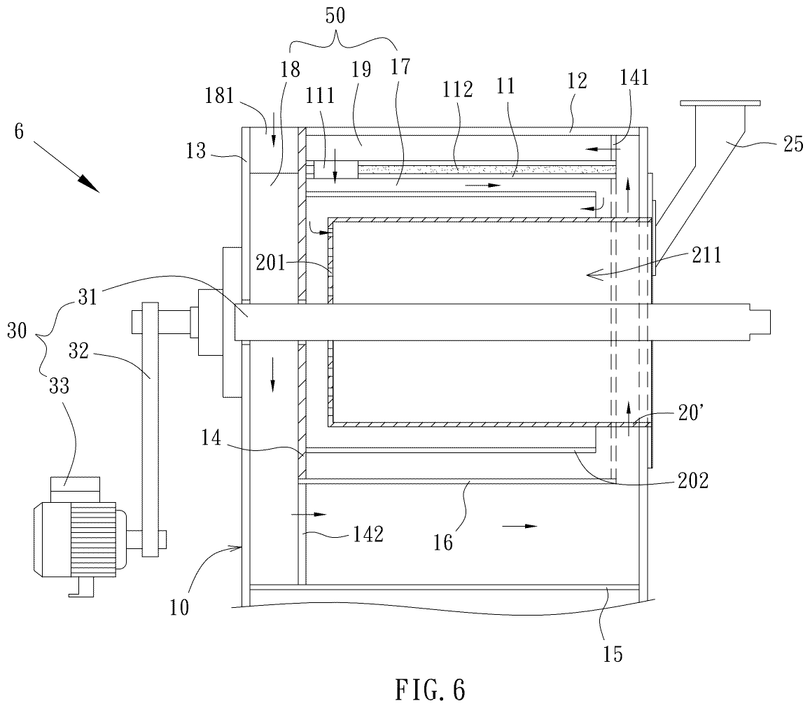

FIG. 6 is a schematic view showing the assembly of a roller 20′ of the heat insulation structure of the roasting machine according to another preferred embodiment of the present invention. The roller 20′ includes a roast room 211 defined therein and communicating the external environment, multiple passing orifices 201 formed on a bottom of the roast room 211, such that the airs flows into the roast room 211 from the external environment via the first flow passageway 18, the second flow passageway 19, the conduit 17, and the multiple passing orifices 201. To enhance a size of the heat exchange space 50 of the body 10, an isolation layer 202 is defined between an outer wall of the roller 20′ and the covering element 11, wherein the heat exchange space 50 extends into the roast room 211 along the body 10 in the S shape to prolong a heat exchanging time of the body before the airs flow into the roast room 211.

The transmission mechanism 30 is configured to actuate the roller 20 to rotate, and the transmission mechanism 30 includes a drive shaft 31, an actuation belt 32, and a reducer motor 33. The drive shaft 31 is connected on a center of the internal cylinder 21, an end of the drive shaft 31 extend out of the internal cylinder 31 to fit with an end of the actuation belt 32, and the other end of the actuation belt 32 is connected with an output end of the reducer motor 22 so that the reducer motor 33 actuates the roller 20 to rotate after being started.

The heating unit 40 is a heater driven by gas, oil or electricity, and the heating unit 40 is located below the roller 20 to heat the roller 20.

Thereby, the covering element 11 and the protective lid 12 cover the roller 20, and the roller 20 communicates with the first flow passageway 18, the second flow passageway 19 and the conduit 17 of the roast room 211 so that when roasting coffee beans by using the roasting machine 6, the airs flows into the body from the external environment via the air feeding mouth 181 of the first flow passageway 18 without passing through the heating unit 40, thus avoiding poor combustion. In addition, when the heating unit 40 operates, a high temperature is transferred to the body but to be isolated by the covering element 11, the heat insulation layer 112, and the protective lid 12. Preferably, the airs flow through the first flow passageway, the second flow passageway 19, and the conduit 17 to exchange the heat with the high temperature of the body so as to avoid a scald by a high temperature generating from the outer wall of the roasting machine 6. Furthermore, when the airs flow into the roast room 211 via the first flow passageway 18, the second flow passageway 19 and the conduit 17, a temperature of the roast room 211 is stable because of the airs, thus decreasing an energy loss of the heating unit 40 and maintaining the temperature of the roast room stably.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A heat insulation structure of a roasting machine, the roasting machine comprising a body in which a roller is fixed, a transmission mechanism, and a heating unit, the roller including a roast room defined in the roller to accommodate crops, the heating unit being mounted on the body, and the transmission mechanism actuating the roller to rotate, when the crops are heated by the roasting machine;
wherein the body includes a closed heat exchange space defined on a top thereof to correspond to the roller, the heat exchange space includes an inlet formed on an end thereof and configured to flow airs from an external environment, and the other end of the heat exchange surrounds the body and communicates with the roasting room of the roller, wherein the heat exchange room extends into the roasting room of the roller along the body and does not pass through the heating unit, thus saving an energy loss of the heating unit and maintaining the temperature of the roast room stably.

2. The heat insulation structure as claimed in claim 1, wherein the heat exchange room extends into the roasting room of the roller along the body in an S shape to increase a flow of the airs and a heat exchanging time of the body.

3. The heat insulation structure as claimed in claim 1, wherein the closed heat exchange space of the body corresponds to the roller and includes a covering element configured to shield the roller and cover by a protective lid, and the protective lid has two first partitions connected on two ends thereof, the covering element has two second partitions connected on two ends thereof, and a third partition is disposed on a bottom of the protective lid; the two second partitions extends to an inner wall of the protective lid, wherein an end of one second partition is connected with a bottom of the covering element, and an end of the other second partition is connected with the third partition, two sides of the second partition correspond to the bottom of the covering element and has an opening defined among the two sides of the covering element and the inner wall of the protective lid, wherein a fourth partition is connected on a top of the opening, and a conduit is defined between the roller and the covering element and communicates with a conduit of a roast room, a first flow passageway and a second flow passageway are defined between the protective lid and the covering element, such that the conduit, the first flow passageway and the second flow passageway define the heat exchange space, wherein the first flow passageway has an air feeding mouth defined on a top of an end thereof; the second partition is configured to separate the first flow passageway from the second flow passageway and has at least one first communication portion defined on a predetermined position thereof so that the first flow passageway is communicated with the second flow passageway; the covering element includes a second communication portion corresponding to the second flow passageway so that the second flow passageway is communicated with the conduit, and the airs flow into the roast room from the air feeding mouth via the first passageway, the second passageway and the conduit.

4. The heat insulation structure as claimed in claim 3, wherein the covering element has a heat insulation layer covering on an outer wall thereof to isolate a heat dissipation from the roller, thus maintaining a heat and avoiding a high temperature of the rotating machine.

5. The heat insulation structure as claimed in claim 3, wherein the roller includes an internal cylinder and an external cylinder, the roast room is defined in the internal cylinder to accommodate crops, the external cylinder is hollowly cylindrical and is located outside the internal cylinder, wherein multiple fins are defined between the internal cylinder and the external cylinder so that the internal cylinder suspends inside the external cylinder, and multiple channels are defined between the internal cylinder and the external cylinder and communicates with the roast room; the conduit communicates with the multiple channels, wherein the airs flow into the roast room via the first flow passageway, the second flow passageway, the conduit and the multiple channels.

6. The heat insulation structure as claimed in claim 3, wherein the first communication portion is a cutout or a through hole.
